(19) United States
(12) Patent Application Publication
(10) Pub. No.: US 2015/0258839 A1
(43) Pub. Date: Sep. 17, 2015

(54) My Office Connection

(71) Applicant: Diane Elisa Falzone, Staten Island, NY (US)

(72) Inventor: Diane Elisa Falzone, Staten Island, NY (US)

(21) Appl. No.: 14/465,262

(22) Filed: Aug. 21, 2014

Related U.S. Application Data
(60) Provisional application No. 61/959,423, filed on Aug. 23, 2013.

(51) Int. Cl. B42F 7/06

(52) U.S. Cl. CPC B42F 7/06

(57) ABSTRACT

My Office Connection, is to date, the only Quad fold carry organizer.

Through many hours of design strategy implementation, we have accomplished our goal for a sample product:
A cost effective, and easy to manufacture product. It has 2 cut-and-sewn ripstop bodies and 2 pockets, a cut and sewn hook fastener, a cut-and-sewn loop fastener strap, a cut and sewn nylon webbing pocket trim, a cut and sewn vinyl tablet pocket and a pocket, and a die cut polyethylene terephthalate armature.
A prototype product sample has been built, and Pro-E technical drawings are available.

### CROSS REFERENCED TO RELATED PROVISIONAL APPLICATION NO. 61/959,423 FILED Aug. 23, 2013)

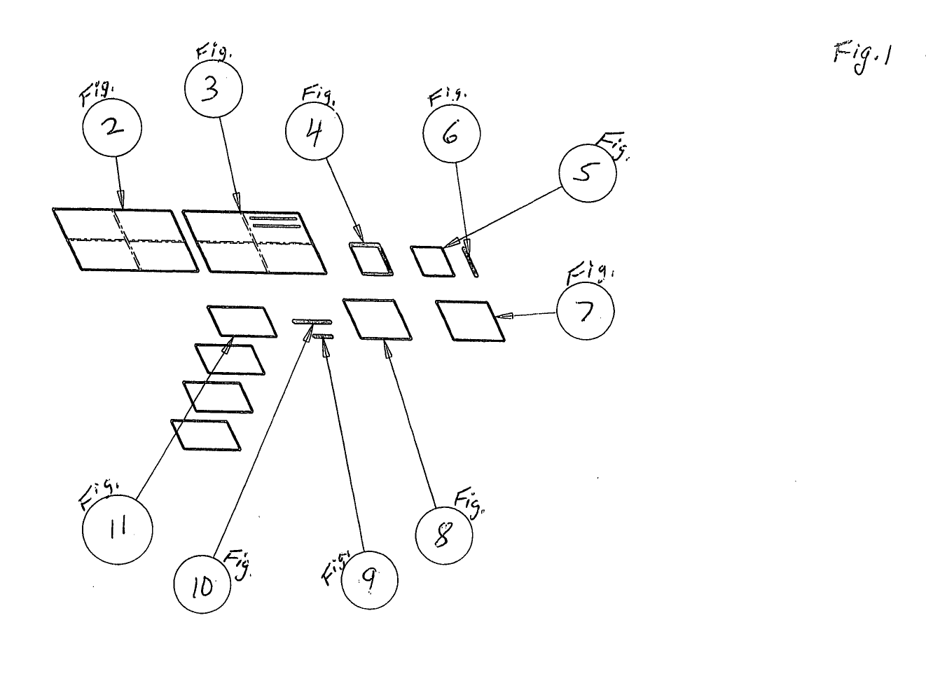

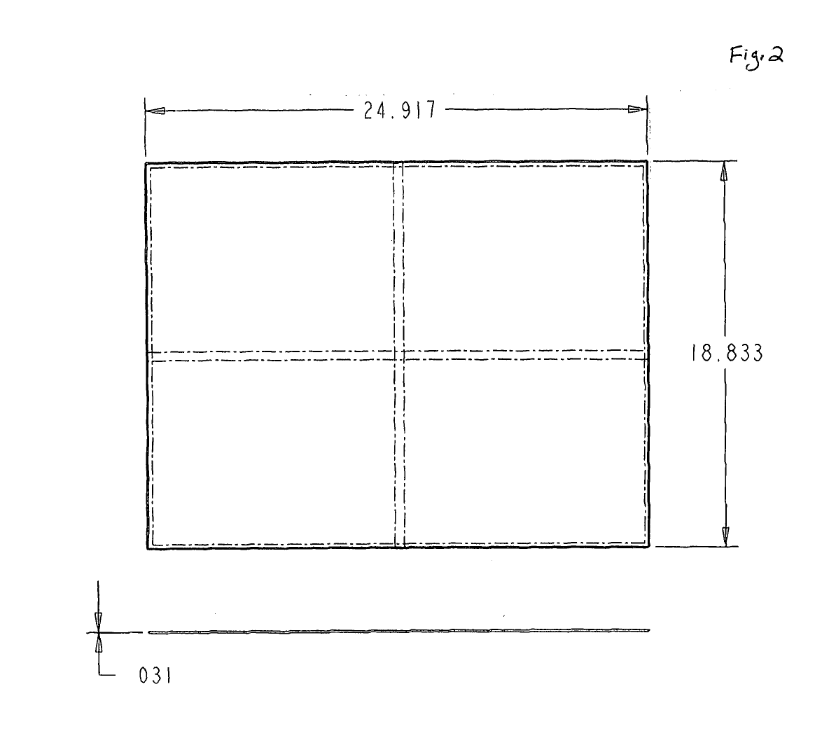

FIG. 1—Full layout of My Office Connection (FIGS. 2-11), parts 2-11.

FIG. 2—The body's four panel compartments.

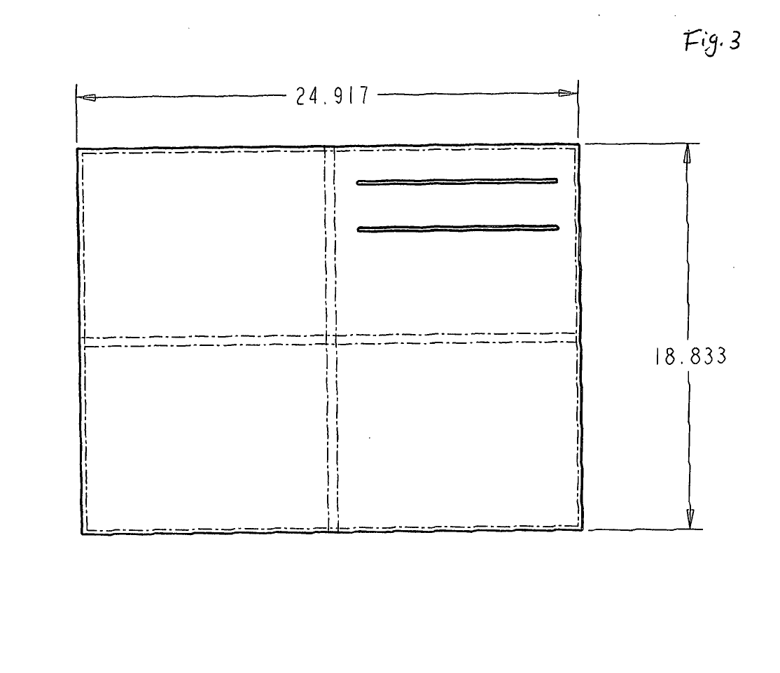

FIG. 3—The body's double lined stitch details separating the four panels.

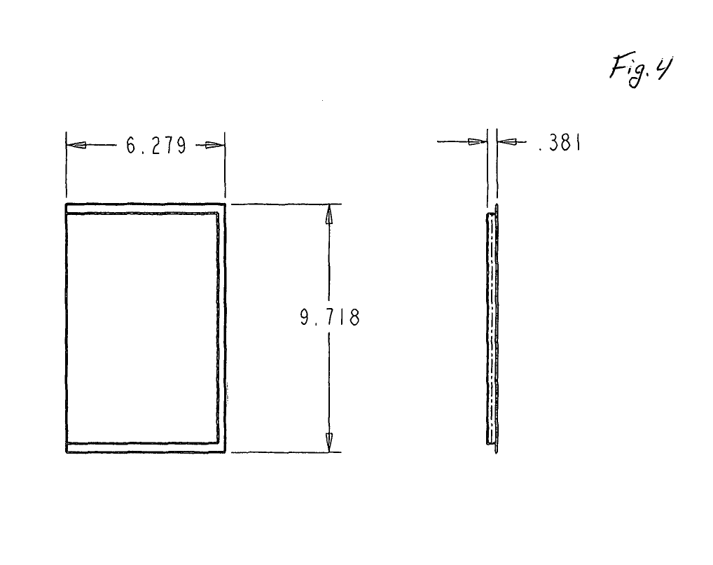

FIG. 4—The upper top right tablet compartment pocket.

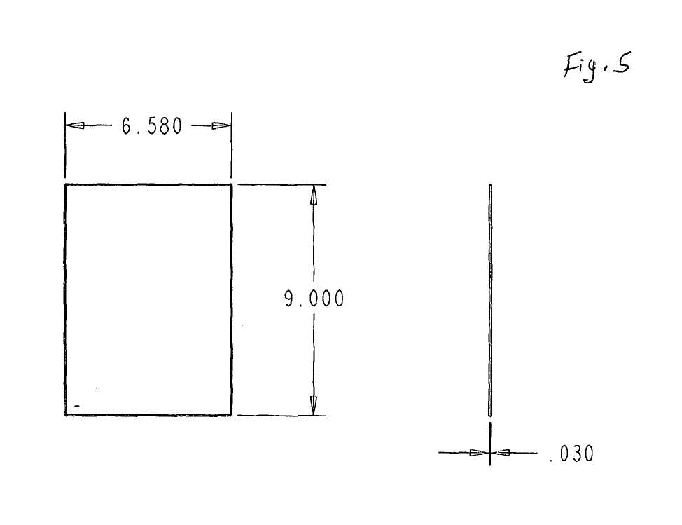

FIG. 5—The lower top right accessory compartment pocket.

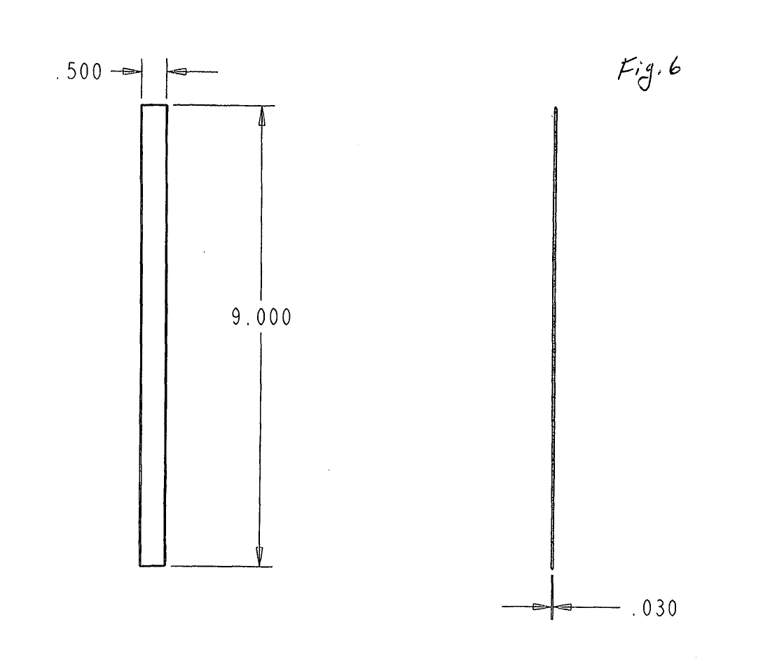

FIG. 6—The trim for both the upper and lower top right tablet compartment pockets.

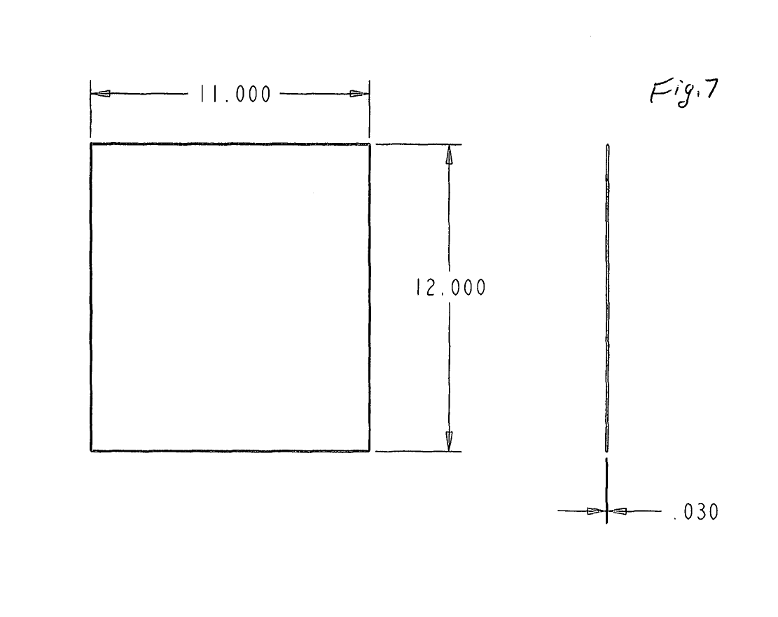

FIG. 7.—The lower left side file compartment pocket.

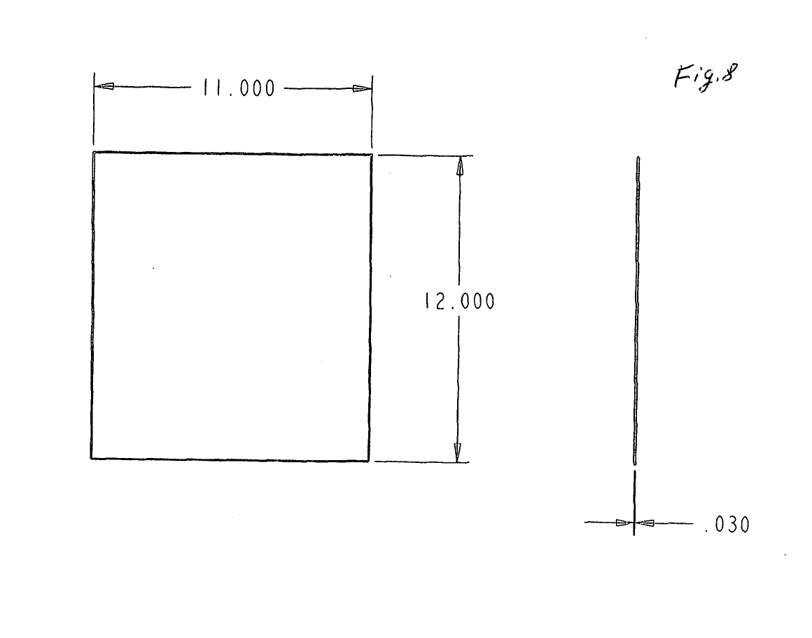

FIG. 8.—The lower left side file compartment pocket.

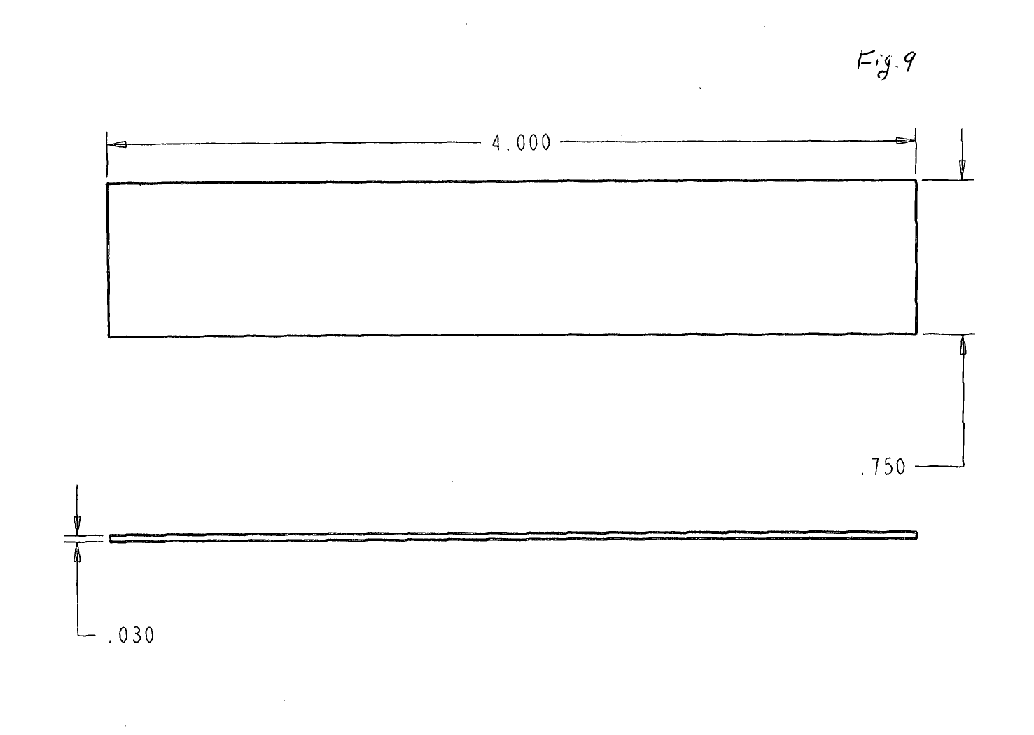

FIG. 9.—Hook for compartment pocket

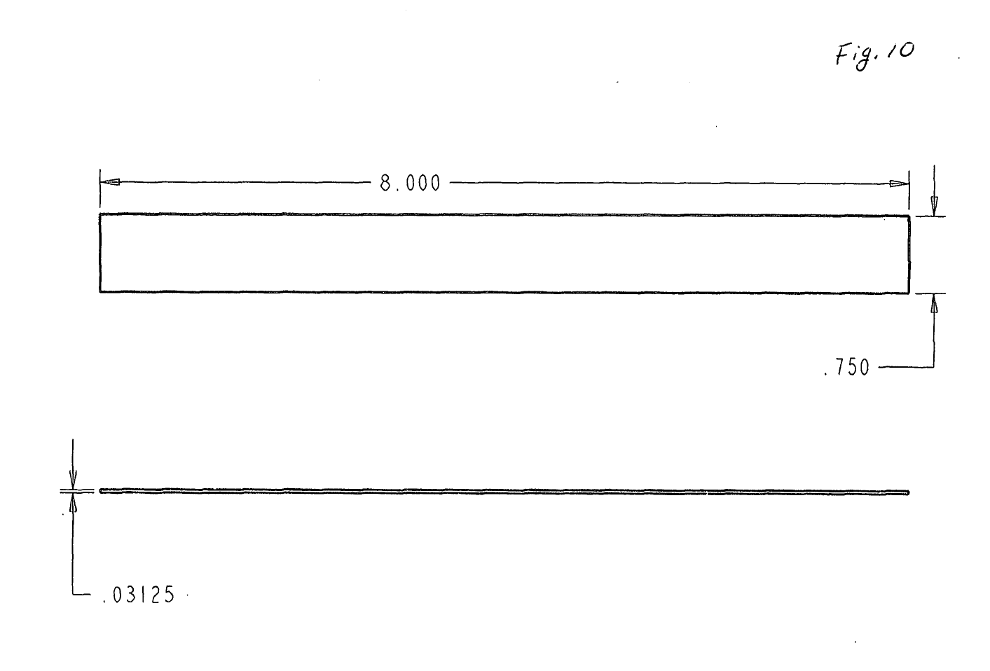

FIG. 10.—Loop strap for enforcement of the quad fold closure.

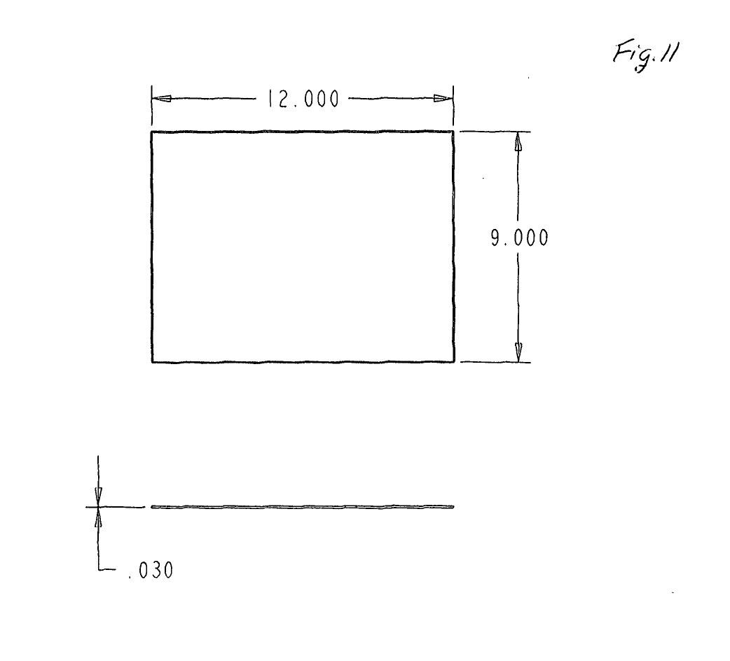

FIG. 11 Armature (bordering for the entire quad fold body).

### NEW DISCOVERY

Do you frequently work out of the office, or are you a student on the move, needing your papers to be organized? If so, then you know how difficult it can be to keep your supplies organized when on the go.

My Office Connection™ has the perfect solution! It is a portable office quad fold organizer. The organizer folds in order to keep all of your items together.

Simply unfold the organizer to reveal and access all of your items. This organizer can hold a tablet, note books and provide a writing surface. Use the sleeve pocket to store all of your papers and receipts and the 2 zip pockets for any other items you need. Take your office on the go, wherever you go, with My Office Connection™!

### How Is It Made?

Our present prototype product sample has been built through many hours of design strategy implementation.

We have accomplished our goal in creating a cost effective and easy to manufacture product. It has 2 cut and sewn ripstop bodies and 2 pockets, a cut and sewn hook fastener, cut and sewn loop fastener straps, a cut and sewn nylon webbing pocket trim, a cut and sewn vinyl tablet pocket and a pocket, and a die cut polyethylene terephthalate armature.

### Created for Versatility

My Office Connection™ was created to bring organization, to our otherwise complex style of living. Instead of throwing our daily on the go needs, whether for business or as a student, into a bag or even an attaché case, in separate compartments, this quad-fold organizer created, will unfold before your eyes, in a very organized visual noncomplex way. Easy to fold, and unfold!

Perfect for use when traveling by airplane, as a carryon item!

As we know, passing through airport security is a timely process. When you are carrying an attaché case, etc., security would have to rummage through your various compartments where most times, pages and folders are stuffed in. But, with My Office Connection™, all your items will be easily viewed with far less time spent in this process.

My Office Connection™, is the perfect solution to a better organized routine, which can increase one's creativity and productivity skills.

1. My Office Connection, to date, is the only Quad fold carry organizer.
This product is presently produced in sz. of 2 ft 3 inches×18.6 inches, with flexible plastic writing tablet inserts for a harder surface to address both durability and writing surface ability. It is presently created in the sample model of durable nylon/vinyl/polyethylene materials with durable stitching, in the color blue. It is presently produced with (2) pocket sleeves, (2) book and/or folder sleeves, in addition to (1) file strap sleeve w/one or two stretch file holders. This product sample is presently built as a carry under arm style.
This product will also be manufactured with a carry handle, and/or with a shoulder strap. In addition, this product will be produced with an additional cell phone pocket insert, as well as a business card/credit card insert holder. It will come in various sizes, colors, and materials, including leather. This product will be produced as a quad fold for all models.
